(19) United States
(12) Patent Application Publication
(10) Pub. No.: US 2006/0165150 A1
(43) Pub. Date: Jul. 27, 2006

(54) Method and apparatus for examining heat pipe temperature using infrared thermography

(76) Inventor: Hul-Chun Hsu, Taichung City (TW)

Correspondence Address: HDSL, 4331 STEVENS BATTLE LANE, FAIRFAX, VA, 22033, US

(21) Appl. No.: 11/043,130

(22) Filed: Jan. 27, 2005

(51) Int. Cl. G01K 19/00

(52) U.S. Cl. 374/2; 374/121; 374/3

(57) ABSTRACT

A method and an apparatus for examining heat pipe temperature using an infrared thermography. The heat pipe is covered with a thin film. The heat transfer temperature of the heat pipe is examined and measured using an infrared thermography or an infrared imager. Since the presence of the thin film can provide a more stable and larger radiation emissivity of the heat pipe surface, a more accurate heat transfer temperature of the heat pipe can thus be obtained from the infrared thermography.

### BACKGROUND OF THE INVENTION

The present invention relates generally to a method and an apparatus for examining heat pipe temperature, and more particularly to a method and an apparatus for examining heat pipe temperature using an infrared thermography or an infrared imager.

Conventionally, the temperature of heat transfer in a heat pipe is measured by using a thermal detection line adhered on the body of the heat pipe. Since each heat pipe should be adhered to a thermal detection line before any measurement is performed, it is very inconvenient when performing mass examination.

With the currently available technology, one can use an infrared thermography or an infrared imager to aid the measurement of heat transfer temperature of the heat pipe. The so-called infrared thermography is also called infrared camera, which is an apparatus including an infrared detector incorporated with optical lenses and electronic circuits. However, the radiation emissivity of the heat pipe surface varies to a large scale due to the stain or oxidation of the heat pipe surface generated in the manufacturing process. On the other hand, since the heat pipe is often made of copper, while the surface of copper is very smooth and bright, the radiation emissivity is thus very low (often smaller than 0.1). Therefore, the ambient environment often renders the measured temperature very unstable, or exceeds the lower limit of emissivity of the infrared thermography. Consequently, the infrared thermography is inapplicable to examine the real heat transfer temperature of the heat pipe.

In light of the above, the inventor of the present invention has developed a new apparatus and method that can solve the problems described above.

### BRIEF SUMMARY OF THE INVENTION

The present invention is to provide a method and an apparatus for examining heat pipe temperature using an infrared thermography or an infrared imager. The infrared thermography or the infrared imager is adaptable to examine and measure the heat transfer temperature of a heat pipe, and solve the problem of temperature measurement instability. A thin film is used to cover the surface of the heat pipe. Since the presence of the thin film can provide a more stable and larger radiation emissivity (approximately between 0.4 and 0.8), a more accurate heat transfer temperature of the heat pipe can thus be obtained.

In order to achieve the above and other objectives, the method of the present invention includes the following steps:
a) heating a reception end of the heat pipe to be examined, and covering a thin film to the portion of the heat pipe to be examined; and
b) examining the portion of the heat pipe covered with the thin film by using an infrared thermography, and measuring the heat transfer temperature of the heat pipe.

In order to achieve the above and other objectives, the apparatus of the present invention is incorporated with at least a heat pipe. A thin film is covered on a portion of the heat pipe to be examined. The apparatus includes a heating unit and an infrared thermography. The heating unit is used for heating the reception end of the heat pipe, while the infrared thermography is located corresponding the position of the heat pipe covered with the thin film. The thin film is disposed between the heat pipe and the infrared thermography. Thus, the apparatus of the present invention for examining a heat pipe using an infrared thermography is obtained.

### BRIEF DESCRIPTION OF THE DRAWINGS

FIG. 1 is a flow diagram illustrating the method of the present invention.

FIG. 2 illustrates a side elevation of the present invention.

FIG. 3 illustrates a front elevation of the present invention.

### DETAILED DESCRIPTION OF THE INVENTION

In order to better understanding the features and technical contents of the present invention, the present invention is hereinafter described in detail by incorporating with the accompanying drawings. However, the accompanying drawings are only for the convenience of illustration and description, no limitation is intended thereto.

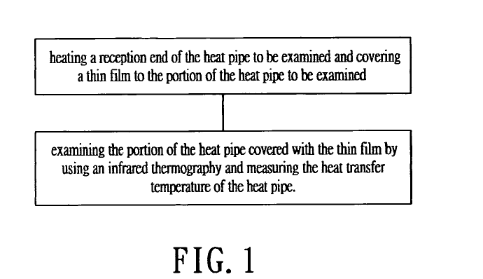

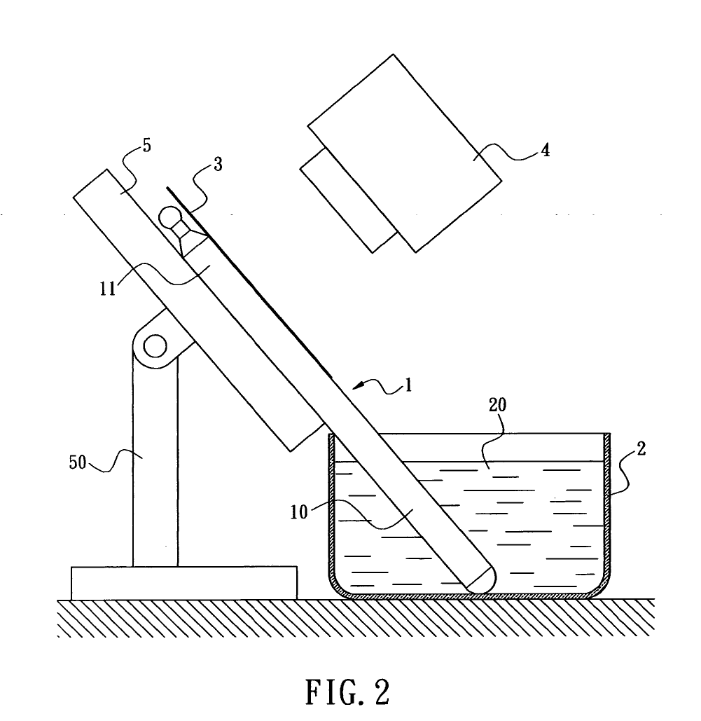

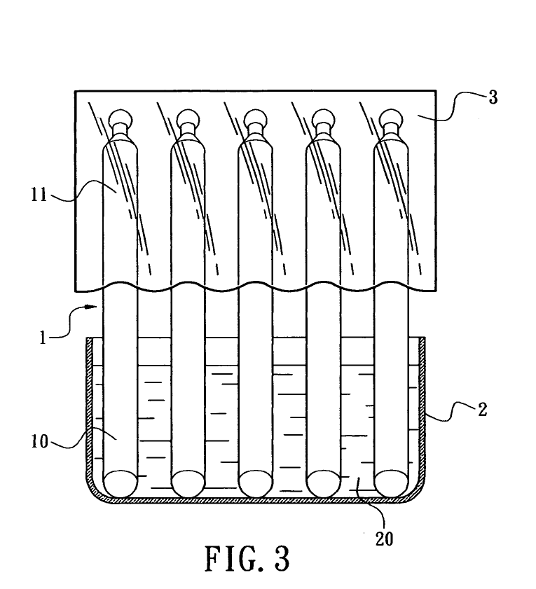

Referring to FIG. 1, a flow diagram of the method of the present invention is illustrated. Referring also to FIG. 2 and FIG. 3, wherein the side elevation and the front elevation of the present invention are illustrated respectively. The present invention provides a method for examining heat pipe temperature using an infrared thermography. The method includes the following steps:

a) The reception end 10 of one or more heat pipes 1 to be examined is heated. A thin film 3 is covered on the portion of the heat pipe to be examined. The reception end 10 of the heat pipe 1 is heated by using a heating unit 2. The heating unit 2 can be a heater, a hot air generator, a heat radiator, or a fluid container. As shown in FIG. 2 and FIG. 3, the heating unit 2 of the present invention is a fluid container, which contains a predetermined amount of heating fluid 20 so as to rinse the reception end 10 of the heat pipe 1 therein for raising the temperature thereof. The heating fluid 20 can be any fluid such as water, mineral oil or vegetable oil.

b) In order to measure the heat transfer temperature of the heat pipe 1, the portion of the heat pipe 1 that is covered by the thin film 3 is examined by using an infrared thermography or an infrared imager.

In addition, the portion to be examined as described in step a) often refers to a cooling end 11 of the heat pipe 1. On the other hand, one can also examine the central portion of the heat pipe 1. The thickness of the thin film 3 is preferably between 0.005 to 0.040 mm. The thin film can be a plastic thin film, such as polyvinyl chloride. Furthermore, some color powder can be added to the thin film for further improving and adjusting the radiation emissivity. At the mean time, an adhesive layer can be applied on the surface of the portion to be examined or on the thin film 3. The adhesive layer can be made of vegetable oil, mineral oil or compound oil. In this particular embodiment, the adhesive layer is glue of low viscosity. The adhesive layer enhances the adhesion between the heat pipe 1 and the thin film 3 for reducing the examination error.

Referring to FIG. 3, a plurality of heat pipe 1 is arranged in parallel for performing mass examination. Only one thin film 3 is required to cover the portion of the heat pipes 1 to be examined. Then, each of the heat pipes 1 is sequentially examined by using the infrared thermography 4. Therefore, the examination process becomes quicker and more convenient.

Referring to FIG. 2 and FIG. 3, the apparatus for examining heat pipe temperature using an infrared thermography is illustrated. The apparatus includes a heating unit 2 and an infrared thermography 4.

The heating unit 2 is used to heat the reception end 11 of the heat pipe 1. As described above, the heating unit 2 can be a heater, a hot air generator, a heat radiator, or a fluid container. In this particular embodiment, the heating unit 2 is a fluid container.

The infrared thermography 4 is disposed corresponding the portion of the heat pipe 1 covered with the thin film 3, i.e. on the cooling end 11 of the heat pipe 1. The thin film is located between the heat pipe 1 and the infrared thermography 4.

In addition, the apparatus further includes a back plate 5 made of a homogeneous material. For example, the entire back plate 5 can be made of a metallic plate, such as copper plate or aluminum plate, or a plastic plate. The back plate 5 is located below the heat pipe 1 covered with the thin film 3, which provides a homogeneous and stable background temperature for the portion of the heat pipe 1 to be examined, so as to enhance the accuracy of the measurement results. Meanwhile, the back plate is formed on a supporting base 50 to better support and position the heat pipes 1.

Therefore, since the thin film 3 provides a larger and more stable radiation emissivity, which is between 0.4 and 0.8, the apparatus of the present invention can obtain a more accurate heat transfer temperature when examining the heat pipe 1 using the infrared thermography 4. This is also applicable to mass examination of heat pipes 1.

Since, any person having ordinary skill in the art may readily find various equivalent alterations or modifications in light of the features as disclosed above, it is appreciated that the scope of the present invention is defined in the following claims. Therefore, all such equivalent alterations or modifications without departing from the subject matter as set forth in the following claims is considered within the spirit and scope of the present invention.

What is claimed is:

1. A method for examining heat pipe temperature, comprising the steps of:
(a) heating a reception end of the heat pipe to be examined, and covering a thin film to the portion of the heat pipe to be examined; and
(b) examining the portion of the heat pipe covered with the thin film by using an infrared thermography, and measuring the heat transfer temperature of the heat pipe.

2. The method as recited in claim 1, wherein the portion of the heat pipe to be examined is a cooling end.

3. The method as recited in claim 1, further comprising the step of applying an adhesive layer on the surface of the portion of heat pipe to be examined, or on the thin film.

4. The method as recited in claim 3, wherein the adhesive layer is made of vegetable oil, mineral oil or compound oil.

5. The method as recited in claim 1, wherein the thickness of the thin film is substantially between 0.005 and 0.040 nm.

6. An apparatus for examining heat pipe temperature, comprising:
a thin film covered on a portion of the heat pipe to be examined;
a heating unit for heating the reception end of the heat pipe, and
an infrared thermography, which is located corresponding the position of the heat pipe covered with the thin film, the thin film being disposed between the heat pipe and the infrared thermography.

7. The apparatus as recited in claim 6, wherein the thickness of the thin film is substantially between 0.005 and 0.040 nm.

8. The apparatus as recited in claim 6, further comprising an adhesive layer applied between the surface of the portion of heat pipe to be examined and the thin film.

9. The apparatus as recited in claim 8, wherein the adhesive layer is made of vegetable oil, mineral oil or compound oil.

10. The apparatus as recited in claim 6, wherein the heating unit comprises a heater.

11. The apparatus as recited in claim 6, wherein the heating unit comprises a hot air generator.

12. The apparatus as recited in claim 6, wherein the heating unit comprises a heat radiator.

13. The apparatus as recited in claim 6, wherein the heating unit comprises a fluid container comprising a heating fluid contained therein.

14. The apparatus as recited in claim 13, wherein the heating fluid is water, mineral oil or vegetable oil.

15. The apparatus as recited in claim 6, further comprising a back plate being disposed below the portion of the heat pipe covered with the thin film.

16. The apparatus as recited in claim 15, further comprising a supporting base for disposing the back plate thereon.
